(19) United States
(12) Patent Application Publication
(10) Pub. No.: US 2024/0194087 A1
(43) Pub. Date: Jun. 13, 2024

(54) INFORMATION PROCESSING APPARATUS AND STORAGE MEDIUM

(71) Applicant: YASHIO Inc., Saitama (JP)

(72) Inventors: Takatoshi MASAMORI, Saitama (JP); Yuki IGAMI, Saitama (JP); Takahiro CHUMA, Saitama (JP)

(21) Appl. No.: 18/525,497

(22) Filed: Nov. 30, 2023

(30) Foreign Application Priority Data
Dec. 7, 2022 (JP) 2022-195947

(51) Int. Cl. G09B 7/04; G06Q 50/20

(52) U.S. Cl. CPC G09B 7/04; G06Q 50/2057; G09B 7/08

(57) ABSTRACT

An information processing apparatus includes, a storage unit that stores a plurality of images respectively representing a plurality of source codes and an execution result corresponding to one source code among the plurality of source codes in association with each other, a creation unit that creates a question page for providing a question that asks skills of imagining a source code from an execution result to a user, the question page including the plurality of images and the execution result, a first transmission unit that transmits data of the question page to a user terminal, a reception unit that receives from the user terminal, answer data that specifies a selected image selected by a user who operates the user terminal among the plurality of images, a determination unit that determines whether an answer to the question is correct or incorrect, and a second transmission unit that transmits a determination result.

### FIELD

Embodiments described herein relate generally to an information processing apparatus and a storage medium.

### BACKGROUND

In recent years. IT engineers having programming skills are appreciated and helpful in creation of websites, construction of databases, improvement of company infrastructures, and the like. Thus, students who enter technical colleges of programming and students who take online classes regarding programming to try to master programming skills have increased. For example, a technology of giving classes to users online via a network such as the Internet, giving users a question and causing the users to answer the question is known (see, for example, Patent Literature 1). However, it is difficult for even a person who has learned programming at a technical college or through online classes to play an active role immediately at actual product development sites. This is because programming is originally very abstract, and even if a person has finished basic learning at a technical college or through online classes, he/she has only mastered programming knowledge and does not know how to use the knowledge. To take programming knowledge mastered through basic learning to programming skills that can be used at actual sites, it is important to gain actual experience along with basic learning. However, iterating basic learning and actual experience a number of times is difficult in structures in the field of education, and in the present state, development sites are entrusted to give actual experience. On the other hand, at actual development sites where budget and time are limited, it is difficult to employ human resources who have only finished basic learning and spend a great deal of time in cultivating the human resources while giving actual experience. Of course, there are a lot of demands to secure human resources who can play active roles immediately as far as possible.

### CITATION LIST

### Patent Literature

[Patent Literature 1] Japanese Patent Application Publication No. 2006-235388

### SUMMARY OF INVENTION

### Technical Problem

To address this, it is desired to provide educational content that can be introduced at technical colleges and through online classes and capable of cultivating human resources who can play active roles at actual development sites. Further, it is desired to provide content capable of measuring whether human resources can play active roles at actual development sites.

### Solution to Problem

An information processing apparatus of the present disclosure comprising, a storage unit that stores a plurality of images respectively representing a plurality of source codes and an execution result corresponding to one source code among the plurality of source codes in association with each other, a creation unit that creates a question page for providing a question that asks skills of imagining a source code from an execution result to a user, the question page including the plurality of images and the execution result, a first transmission unit that transmits data of the question page to a user terminal, a reception unit that receives from the user terminal, answer data that specifies a selected image selected by a user who operates the user terminal among the plurality of images, a determination unit that determines whether an answer to the question is correct or incorrect in accordance with the answer data, and a second transmission unit that transmits a determination result as to whether the answer is correct or incorrect to the user terminal.

### BRIEF DESCRIPTION OF THE VIEWS OF THE DRAWING

FIG. 1 is a view illustrating an example of the whole system including an information processing apparatus according to a first embodiment.

FIG. 2 is a hardware configuration diagram of the information processing apparatus according to the first embodiment.

FIG. 3 is a view indicating an example of a learning database stored in a storage device in FIG. 2.

FIG. 4 is a view illustrating an example of a template of a web page for providing a question stored in the storage device in FIG. 2.

FIG. 5 is a view illustrating an example of a template of a web page for incorrect answer stored in the storage device in FIG. 2.

FIG. 6 is a view illustrating an example of a template of a web page for correct answer stored in the storage device in FIG. 2.

FIG. 7 is a flowchart indicating an example of procedure of processing of providing a question related to a learning service by the information processing apparatus according to the first embodiment.

FIG. 8 is a view indicating an example of a front page of a learning site to be provided by the information processing apparatus according to the first embodiment.

FIG. 9 is a view illustrating a state where an option 1 is selected in the web page for providing a question of the learning site to be provided by the information processing apparatus according to the first embodiment.

FIG. 10 is a view illustrating a state where an option 2 is selected in the web page for providing a question of the learning site to be provided by the information processing apparatus according to the first embodiment.

FIG. 11 is a view illustrating a state where an option 3 is selected in the web page for providing a question of the learning site to be provided by the information processing apparatus according to the first embodiment.

FIG. 12 is a view illustrating an example a web page for correct answer to be provided by the information processing apparatus according to the first embodiment.

FIG. 13 is a view illustrating an example a web page for incorrect answer to be provided by the information processing apparatus according to the first embodiment.

FIG. 14 is a view indicating other example of a learning database stored in a storage device in FIG. 2.

FIG. 15 is a view indicating an example of a learning database stored in a storage device in the information processing apparatus according to the second embodiment.

FIG. 16 is a view indicating an example of a learning database stored in a storage device in the information processing apparatus according to the third embodiment.

FIG. 17 is a flowchart indicating an example of procedure of processing of providing a question related to a learning service by the information processing apparatus according to the third embodiment.

FIG. 18 is a view illustrating an example a web page for providing a question to be provided by the information processing apparatus according to the third embodiment.

FIG. 19 is a view illustrating a state where a source code portion on the sixth line is selected in the web page for providing a question in FIG. 18.

FIG. 20 is a view illustrating a state where a plurality of source code portions are displayed as options in the web page for providing a question in FIG. 18.

### DETAILED DESCRIPTION

An information processing apparatus according to the present embodiment will be described below with reference to the drawings. In the following description, components having substantially the same functions and configurations will be denoted by the same reference numerals, and redundant description will be provided only when necessary.

The information processing apparatus according to the present embodiment is a computer apparatus having various kinds of functions necessary to provide a programming learning service to users. One feature of the information processing apparatus according to the present embodiment is that questions regarding programming (hereinafter, simply referred to as questions) to be provided to the users in the programming learning service are constituted so as to allow the users to master skills necessary in an actual product development. Details thereof will be described later.

Three embodiments with different types of questions will be sequentially described below.

### First Embodiment

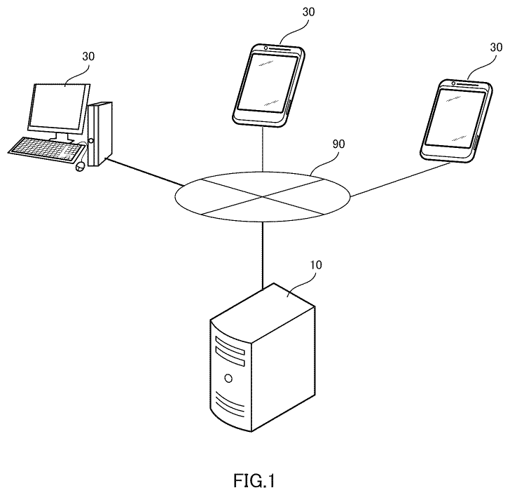

As illustrated in FIG. 1, a plurality of user terminals 30 are connected to an information processing apparatus 10 according to a first embodiment via a network 90 such as the Internet. The user terminal 30 is implemented by a general information processing terminal such as a personal computer, a tablet and a smartphone.

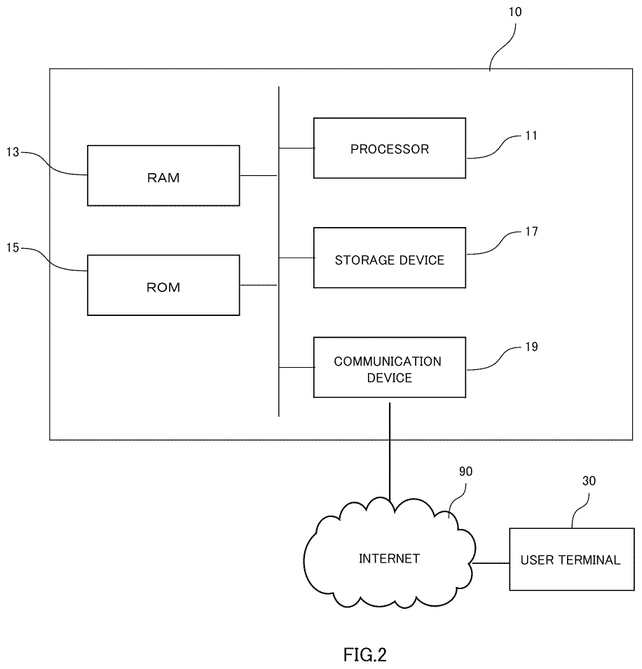

As illustrated in FIG. 2, the information processing apparatus 10 is constituted by hardware such as a RAM 13, a ROM 15, a communication device 19 and a storage device 17 being connected to a processor 11. The processor 11 is implemented by a CPU, or the like. The communication device 19 is implemented by a communication module complying with arbitrary communication standards. The communication device 19 transmits/receives various kinds of data to/from the user terminals 30 in accordance with control by the processor 11. The storage device 17 is implemented by an HDD, an SSD, or the like, that is a non-volatile storage medium. The storage device 17 stores a program related to a programming learning service (hereinafter, referred to as a learning program) and various kinds of data to be utilized in the learning service. The various kinds of data to be utilized in the learning service include a learning database, and template data of various kinds of web pages to be displayed at the user terminals 30. The templates of various kinds of web pages include a template of a web page for providing a question, a template of a web page for incorrect answer and a template of a web page for correct answer. The learning program may be stored in a portable non-volatile storage medium such as a CD-ROM or a USB memory as well as the above-described HDD and SSD.

The learning program, and data necessary to provide a learning service such as various kinds of data to be used in the learning program may be recorded in removable media and distributed to users or may be distributed by being downloaded to the information processing apparatus 10 via a network.

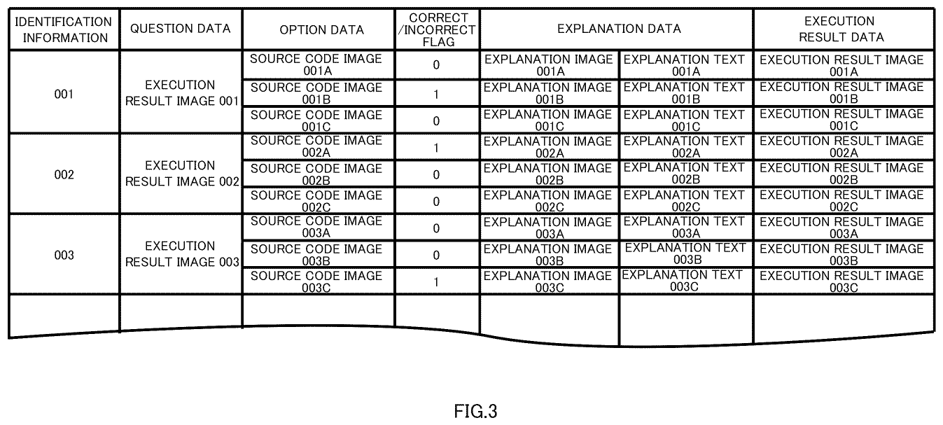

The learning database is a database in which questions to be provided to users are collected. The learning database is provided for each collection of questions including a plurality of questions. As indicated in FIG. 3, in the learning database, question data, option data, a correct/incorrect flag, explanation data and execution result data are associated with identification information for identifying the question. Typically, the question data is provided by data of an image representing an execution result (execution result image). The option data is provided by data of an image representing a source code (source code image). The correct/incorrect flag represents whether or not the corresponding source code is correct. For example, the correct/incorrect flag of “1” indicates that the corresponding source code is correct, and the correct/incorrect flag of “0” indicates that the corresponding source code is incorrect. The explanation data includes data of an explanation image and data of an explanation text. The explanation image is an image in which information of an object, and the like, for specifying a portion for which whether the source code is correct or incorrect is questioned in the question is written in the corresponding source code image. The explanation text explains a reason why the corresponding source code is correct or incorrect. The execution result data is provided by data of an image representing an execution result of the corresponding source code.

Specifically, the question data of “execution result image 001” and the option data of “a plurality of source code images 001A, 001B and 001C” are associated with the identification information of “001”. Further, the correct/incorrect flag of “0”, the explanation data of “explanation image 001A, explanation text 001A” and the execution result data of “execution result image 001A” are associated with the option data of “source code image 001A”.

Note that the execution result data corresponding to a source code that is correct becomes the same as the question data. For example, in the question of the identification information of “001”, the question data of “execution result image 001” becomes the same as the execution result data of “execution result image 001B” with which the correct/incorrect flag of “1” is associated. Thus, the question data may be provided by data of one execution result among a plurality of execution results respectively corresponding to a plurality of source codes, and in this case, the question data can be omitted in the learning database.

The web page for providing a question is a web page having a function of displaying a question to be provided to a user, a function of displaying a plurality of options, and a function of accepting one option selected by the user from the plurality of options as an answer result.

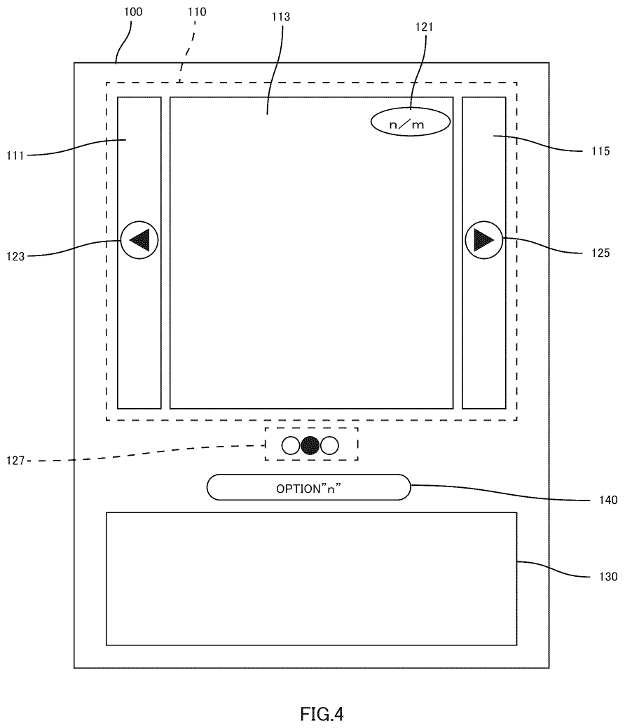

For example, as illustrated in FIG. 4, a template 100 of the web page for providing a question includes a first area 110 in which a plurality of source code images are put, a second area 130 in which an execution result image that is question data is put, a plurality of radio buttons 127 indicating a source code image that is being selected, and an answer button 140 for accepting one source code among the plurality of source codes from the user as an answer result.

Typically, the first area 110 is constituted so that a plurality of source code images are displayed one by one in a slide format. Specifically, the first area 110 includes an area 113 in which the whole of an (n)-th (where n is a natural number equal to or greater than 2) source code image among the plurality of source code images is displayed, an area 111 in which part of an (n−1)-th source code image is displayed, and an area 115 in which part of an (n+1)-th source code image is displayed. Further, the first area 110 includes an area 121 for displaying information that specifies the source code image that is being selected along with a total number of the source code images, and switching buttons 123 and 125 for switching the source code image that is being selected. The source code image for which the whole image is displayed in the area 113 corresponds to the source code image that is being selected. A number for specifying the source code image that is being selected is allocated to “n” described on the answer button 140. A total number of source code images is allocated to “m” described in the area 121, and the number for specifying the source code image that is being selected is allocated to “n”. For example, by clicking the switching button 125, the source code image that is being selected can be switched from the (n)-th source code image to the (n+1)-th source code image. If the answer button 140 is clicked, information that specifies the source code image that is being selected when the answer button 140 is clicked is transmitted to the information processing apparatus 10 as answer data.

The web page for incorrect answer is a web page which is displayed in a case where the answer of the user to the question provided in the web page for providing a question is “incorrect”, and which has a function of giving a notification that the answer of the user is “incorrect” and a function of displaying explanation of the question.

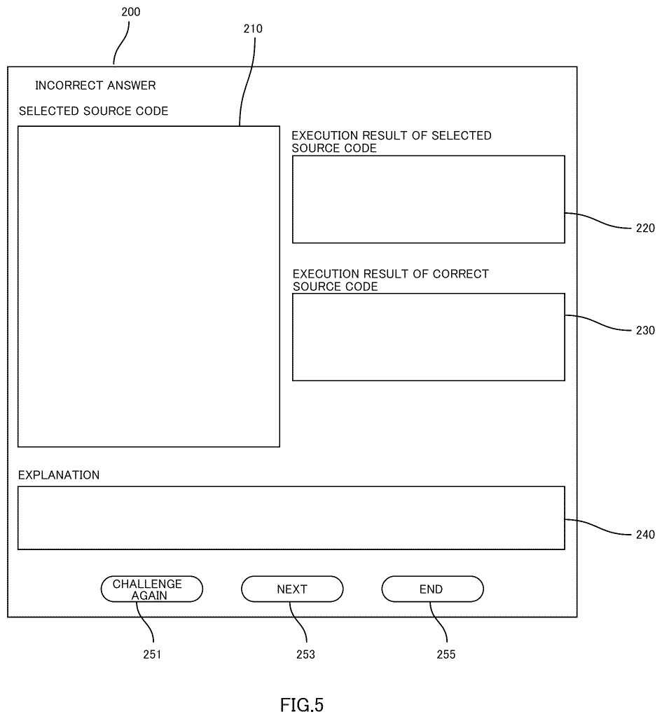

For example, as illustrated in FIG. 5, a template 200 of the web page for incorrect answer includes an area 210 to which an explanation image corresponding to the source code selected by the user as an answer to the question is allocated, an area 220 to which an execution result of the source code selected by the user is allocated, an area 230 to which an execution result of a correct source code is allocated, an area 240 to which explanation comment corresponding to the source code selected by the user is allocated, and a plurality of buttons 251, 253 and 255 allowing the user to input next action. The button 251 is a button for challenging the same question again. The button 253 is a button for proceeding to the next question. The button 255 is a button for finishing learning.

The web page for correct answer is a web page which is displayed when the answer of the user to the question provided in the web page for providing a question is “correct”, and which has a function of giving a notification that the answer of the user is “correct” and a function of displaying explanation of the question.

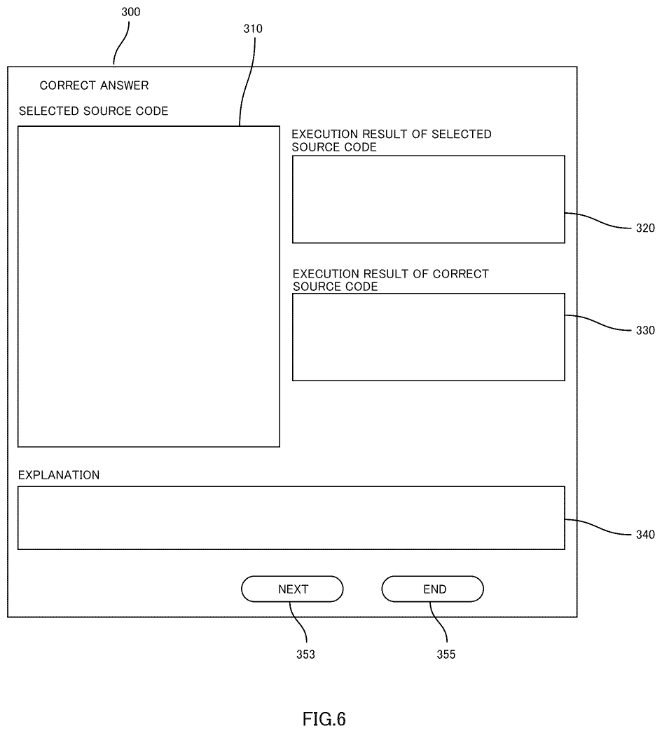

For example, as illustrated in FIG. 6, a template 300 of the web page for correct answer includes an area 310 to which the source code image selected by the user as an answer to the question is allocated, an area 320 to which an execution result of the source code selected by the user is allocated, an area 330 to which an execution result of a correct source code is allocated, an area 340 to which explanation comment corresponding to the source code image selected by the user is allocated, and a plurality of buttons 353 and 355 allowing the user to input the next action. The button 353 is a button for proceeding to the next question. The button 355 is a button for finishing learning.

The information processing apparatus 10 according to the first embodiment functions as a transmission unit that transmits data to the user terminal 30, a reception unit that receives data from the user terminal 30, a login processing unit that executes login processing, a creation unit that creates various kinds of web pages related to a learning service, and a determination unit that determines an answer result of the user by the learning program being executed by the processor.

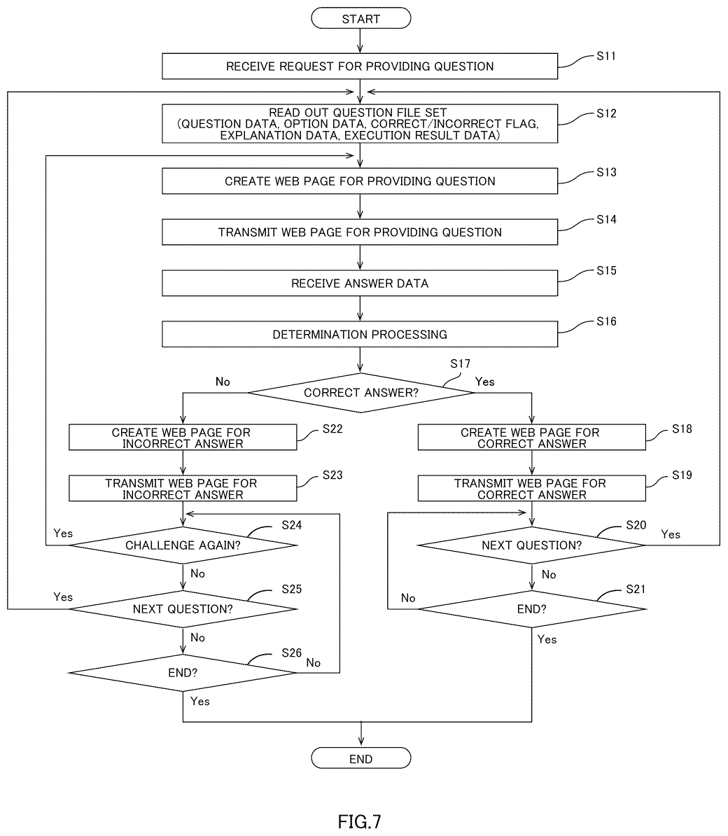

The learning service to be provided by the information processing apparatus 10 according to the first embodiment will be described below with reference to FIG. 7. The learning service is a service of providing questions with explanation regarding programming to the user. FIG. 7 is a flowchart indicating an example of procedure of processing related to the learning service to be provided by the information processing apparatus 10 according to the first embodiment.

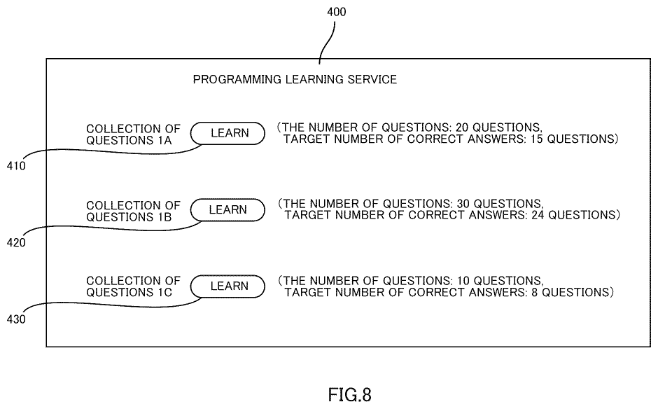

The information processing apparatus 10 executes authentication processing with a user ID and a password received from the user terminal 30. A front page 400 of a site (learning site) that provides the learning service is displayed at the user terminal 30 which has passed the authentication processing (see FIG. 8). As illustrated in FIG. 8, a list of a plurality of collections of questions are displayed on the front page 400 along with a plurality of buttons 410, 420 and 430 respectively corresponding to the collections of questions. A request for providing a question including identification information that identifies a collection of questions to be learned is transmitted from the user terminal 30 to the information processing apparatus 10 on the basis of the button 410, 420 or 430 being clicked by the user.

As indicated in FIG. 7 if the information processing apparatus 10 receives the request for providing a question (S11), the information processing apparatus 10 specifies the collection of questions corresponding to the identification information and reads out a question file set (question data, option data, a correct/incorrect flag, explanation data, execution result data) corresponding to the first question with reference to the question database of the specified collection of questions (S12). Then, the information processing apparatus 10 creates a web page 190 for providing a question in which question data and option data are put in the template 100 of the web page for providing a question illustrated in FIG. 4 (S13) and transmits data of the created web page 190 for providing a question to the user terminal 30 (S14).

As illustrated in FIG. 7, if the information processing apparatus 10 receives answer data from the user terminal 30 (S15), the information processing apparatus 10 determines whether the answer to the question is correct or incorrect in accordance with the answer data (S16). For example, the information processing apparatus 10 determines that the answer of the user is incorrect if the correct/incorrect flag is “0” and determines that the answer of the user is correct if the correct/incorrect flag is “1” with reference to the correct/incorrect flag corresponding to the source code image selected by the user.

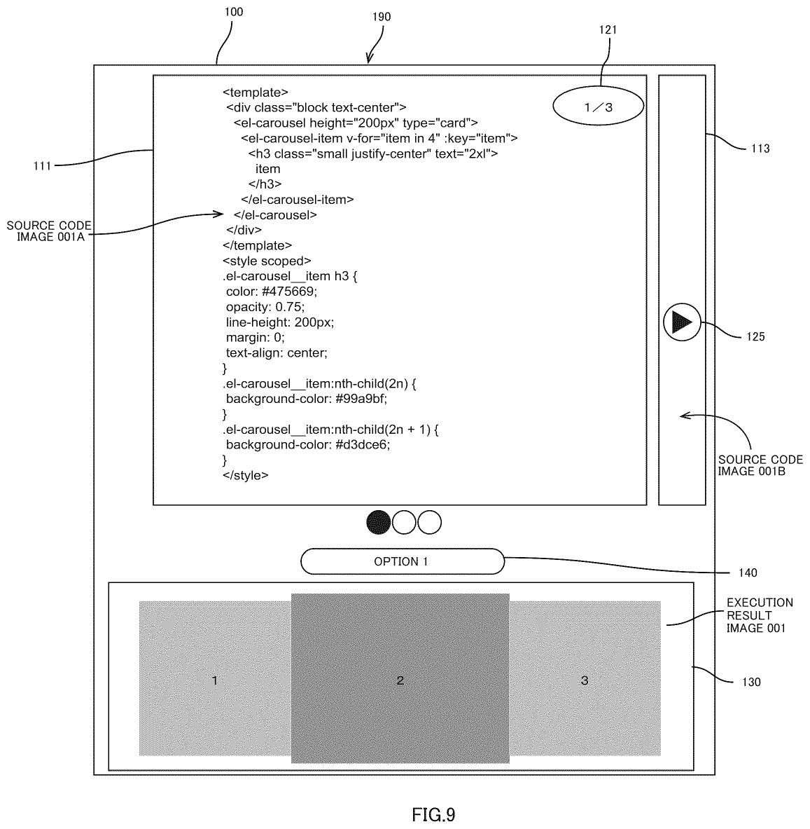

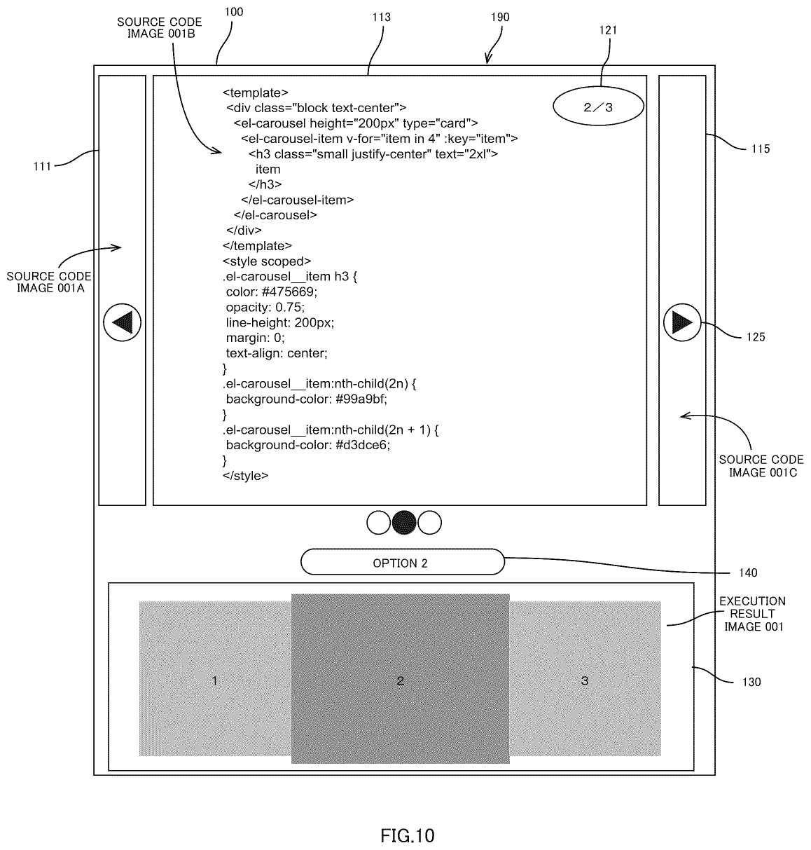

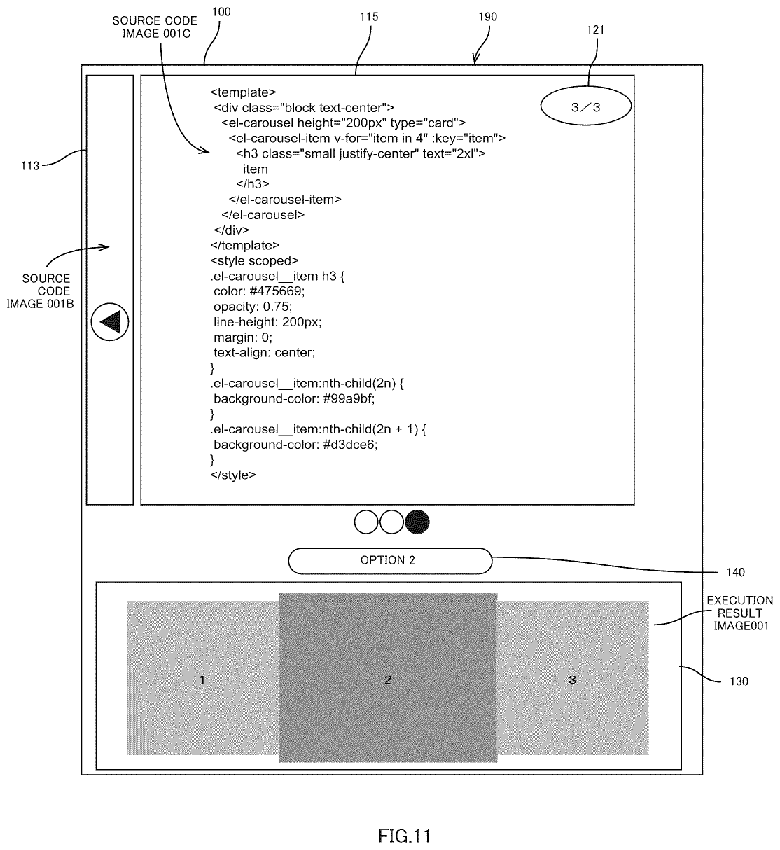

For example, in a case where a question corresponding to the identification information of “001” in the question database indicated in FIG. 3 is provided, the web pages 190 for providing a question illustrated from FIG. 9 to FIG. 11 are created by putting the source code images 001A. 001B and 001C respectively in the areas 111, 112 and 113 of the template 100 of the web page for providing a question illustrated in FIG. 4, putting the execution result image 001 in the second area 130, describing a total number of options of “3” in “m” in the area 121 and describing a number for specifying the source code that is being selected in “n” through processing in step S13, and the web pages 190 for providing a question are displayed at the user terminal 30 through processing in step S14. FIG. 9. FIG. 10 and FIG. 11 respectively illustrate states where the source code images 001A. 001B and 001C are selected by the user. For example, in the web page 190 for providing a question illustrated in FIG. 9, if the answer button 140 is clicked, answer data including information that specifies the source code image 001A is transmitted from the user terminal 30 to the information processing apparatus 10. The information processing apparatus 10 determines that the answer of the user is incorrect on the basis that the correct/incorrect flag corresponding to the answer data is “0”.

If the answer of the user is correct (S17: Yes), the information processing apparatus 10 creates a web page 390 for correct answer on the basis of data of the template 300 of the web page for correct answer, question data, explanation data and execution result data (S18) and transmits data of the created web page 390 for correct answer to the user terminal 30 (S19). Then, the information processing apparatus 10 stands by for an instruction regarding the next action from the user terminal 30 (S20: No. S21: No). If the information processing apparatus 10 receives an instruction to proceed to the next question (S20: Yes), the processing returns to the processing in step S12, and the information processing apparatus 10 provides the next question. On the other hand, if the information processing apparatus 10 receives an instruction to finish the question (S21: Yes), the information processing apparatus 10 finishes providing a question.

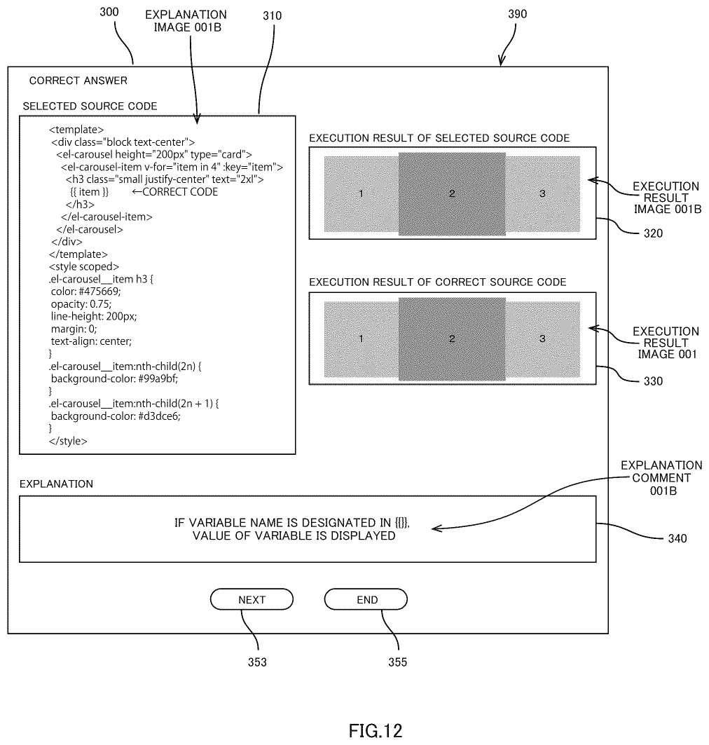

For example, if the question including the identification information of “001” in the question database indicated in FIG. 3 is provided, and the source code image selected by the user is the source code image 001B, the information processing apparatus 10 determines that the answer of the user is correct through the processing in step S17, creates the web page 390 for correct answer illustrated in FIG. 12 by putting the explanation image 001B in the area 310 of the template 300 of the web page for correct answer, putting the execution result image 001B in the area 320, putting the execution result image 001 in the area 330 and putting the explanation text 001B in the area 340 through the processing in step S18, and displays the web page 390 for correct answer at the user terminal 30 through the processing in step S19. In the web page 390 for correct answer displayed at the user terminal 30, if the “next” button 353 is clicked, the web page for providing a question corresponding to the next question is displayed, and if the “end” button 355 is clicked, the front page 400 is displayed.

If the answer of the user is incorrect (S17: No), the information processing apparatus 10 creates a web page 290 for incorrect answer (S22) on the basis of data of the template 200 of the web page for incorrect answer, question data, explanation data and execution result data and transmits data of the created web page 290 for incorrect answer to the user terminal 30 (S23). Then, the information processing apparatus 10 stands by for an instruction regarding the next action from the user terminal 30 (S24: No. S25: No. S26: No). If the information processing apparatus 10 receives an instruction to challenge the question again (S24: Yes), the processing returns to the processing in step S13, and the information processing apparatus 10 provides the same question to the user again. If the information processing apparatus 10 receives an instruction to proceed to the next question (S25: Yes), the processing returns to the processing in step S12, and the information processing apparatus 10 provides the next question. If the information processing apparatus 10 receives an instruction to finish the question (S26: Yes), the information processing apparatus 10 finishes providing a question.

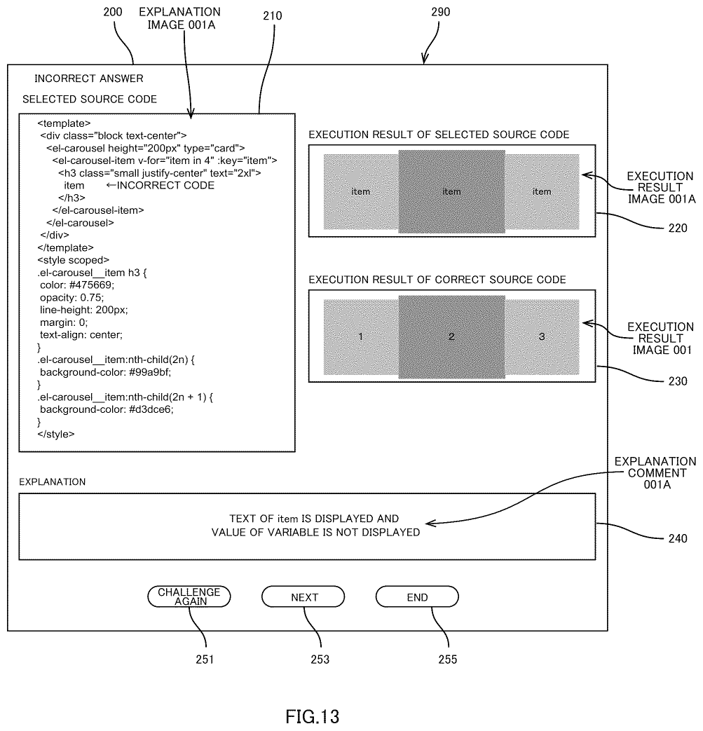

For example, if the question including the identification information of “001” in the question database indicated in FIG. 3 is provided, and the source code image selected by the user is the source code image 001A, the information processing apparatus 10 determines that the answer of the user is “incorrect” through the processing in step S17, creates the web page 290 for incorrect answer illustrated in FIG. 13 by putting the explanation image 001A in the area 210 of the template 200 of the web page for incorrect answer, putting the execution result image 001A in the area 220, putting the execution result image 001 in the area 230 and putting the explanation text 001A in the area 240 through the processing in step S22, and displays the web page 290 for incorrect answer at the user terminal 30 through the processing in step S23. If a “challenge again” button 251 is clicked in the web page 290 for incorrect answer displayed at the user terminal 30, the web page for providing a question corresponding to the same question is displayed again, if a “next” button 253 is clicked, the web page for providing a question corresponding to the next question is displayed, and if an “end” button 255 is clicked, the front page 400 is displayed.

According to the information processing apparatus 10 according to the first embodiment, by displaying the web page for providing a question including an execution result and a plurality of source code images at the user terminal 30, it is possible to provide a question that causes the user to select a source code corresponding to an execution result from a plurality of source codes, to the user. A mistake portion in the source code is unclear, and thus, the user has to read each of the source codes from the top, assemble an execution result of each of the source codes in his/her head and determine whether or not the assembled execution result is the same as the execution result of the provided question in order to answer the question. In other words, it is possible to cause the user to semi-forcibly read the whole of each of the source codes through the question. By causing the user to repeatedly answer such a question, it is possible to cause the user to naturally acquire skills of reading a source code, skills of imagining a source code from an execution result, skills of expanding an execution result from a source code also necessary at actual development sites, so that it is possible to cultivate human resources capable of playing active roles at actual development sites.

Further, with a question constituted along an actual development case, it is possible to cause the user to gain experience close to actual experience. For example, by causing the user to read a correct source code that is actually created and a source code which is actually created and which includes a mistake portion for one product (execution result), it is possible to cause the user to experience in a pseudo manner what kind of mistake is actually made in a development process of the product through the question.

This effect is difficult to obtain from a question that causes the user to select an execution result corresponding to a source code from a plurality of execution results. This is because a clear difference appears in the plurality of execution results, and thus, the user can select an execution result that is a correct answer without reading the whole source code by only focusing attention on a source code portion in which the difference appears. Further, such a question cannot cause the user to read a correct source code and a source code including a mistake portion for one execution result, and thus, cannot cause the user to gain experience close to actual experience through the question. In this manner, a question that causes the user to select a source code corresponding to an execution result from a plurality of source codes, provided in the first embodiment has clear advantages over a question that causes the user to select an execution result corresponding to a source code from a plurality of execution results.

In the first embodiment, in order to cause the user to read the whole of each of the source codes, ingenuity of limiting a source code image for which the whole image is displayed to one is made. This makes it impossible for the user to compare source codes, so that it is possible to avoid a situation where the user tries to find a portion with a difference between the source codes. In order to avoid the user from trying to find a portion with a difference between the source codes, three or more source code images are preferably provided as options.

Further, in the first embodiment, in order to prevent texts of source codes from being easily copied for the purpose of comparison between the source codes, or the like, ingenuity of providing source codes as not texts but as images is made. This is one feature of the information processing apparatus 10 according to the first embodiment.

While in the first embodiment, a slide format is employed to alternatively display a plurality of source code images, the display format is not limited to this if a plurality of source code images can be alternatively displayed. For example, a plurality of radio buttons respectively corresponding to a plurality of source code images may be provided, and a source code image for which the whole image is displayed may be switched through selection operation of the plurality of radio buttons.

Note that alternatively displaying a plurality of source code images refers to displaying one source code image so that the user can browse the whole of the one source code image, among the plurality of source code images. This intends to perform display while avoiding the user from comparing the two source code images. Thus, only one source code image may be displayed, or the other source code image may be partially displayed while the whole of one source code image is displayed. As illustrated in FIG. 10, it is also possible to display the source code image 001B so that the user can browse the whole of the source code image 001B and display only part of other source code images 001A and 001C so that the user cannot browse the whole of the source code images 001A and 001C. Displaying the source code image so that the user can browse the whole of the source code image includes displaying the source code image so that the user can browse the whole of the source code image as a result of user operation such as scrolling operation.

The source code image may be an image representing the whole of the source code from which an execution result is to be expanded or may be an image representing part of the source code from which an execution result is to be expanded.

In the first embodiment, a plurality of source code images are alternatively displayed in the web page for providing a question so that the user cannot compare the source codes. However, if it is allowed to compare the source codes, the whole of at least two source code images among the plurality of source code images may be displayed in the web page for providing a question, and a list of the whole of all the source code images may be displayed.

A form of answering the question provided in the first embodiment is a so-called alternative form that causes the user to select one source code from a plurality of source codes. However, the form of answering the question is not limited to the alternative form, and a so-called multiple-choice form that causes the user to select an arbitrary number of source codes from a plurality of source codes may be employed. In a case where the multiple-choice form is employed, the question is constituted so that while description is different, at least two source codes from which execution results that are the same as an execution result of the provided question are to be expanded are included in a plurality of source codes that are options.

Further, the question may cause the user to select one optimal source code in terms of scalability, maintainability, or the like, while the question is constituted so that while description is different, at least two source codes from which execution results that are the same as the provided question (execution result) are to be expanded are included in a plurality of source codes. For example, in a case where there are a source code in which a variable is not defined and a numerical value is used as is, and a source code in which a variable is defined, and the same execution result as the execution result of the provided question is expanded from these two source codes, the source code in which a variable is defined can be made the best answer in terms of maintainability and scalability.

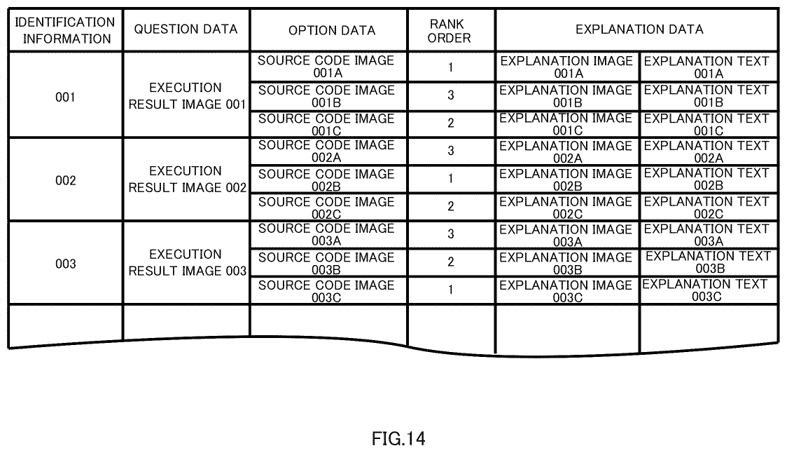

Further, the question may cause the user to rank each of the plurality of source codes in terms of scalability, maintainability, or the like, while the question is constituted so that the same execution result as the execution result of the provided question is expanded from all of the plurality of source codes while description is different. In this case, the correct/incorrect flag in the learning database described in FIG. 3 is replaced with rank order as indicated in FIG. 14. In the learning database indicated in FIG. 14, numbers “1”, “2” and “3” represent rank order, and it is indicated that the source code image 001A corresponding to the number “1” is the best answer.

In the first embodiment, the question presents only an execution result and causes the user to select one source code from a plurality of source codes. However, backup materials such as specifications, requirement definition documents, design files and API documents for creating a source code may be presented along with the execution result. In other words, the backup materials may be displayed in the web page for providing a question along with the execution result.

While in the first embodiment, the question data and the execution result data are images representing the execution result, the question data and the execution result data are not limited to images and may be moving images, or the like, if the question data and the execution result data represent the execution result. If the execution result is an error, an error image may be used.

Questions that can be provided by the information processing apparatus 10 according to the first embodiment can be also used for an employment test or a programming skill examination as well as learning. By using the questions that can be provided by the information processing apparatus 10 according to the first embodiment for an employment test, it is possible to quantitatively evaluate whether a potential employee is a person having programming skills necessary to play an active role at actual development sites and use the evaluation result as information for making a decision as to whether or not to employ the potential employee. In other words, it is possible to find human resources who actually play active roles from a plurality of potential employees. Further, by using the questions that can be provided by the information processing apparatus 10 according to the first embodiment for a programming skill examination, a level of programming skills necessary to play an active role at actual development sites can be measured for each person who takes the examination.

Note that in a case where the questions that can be provided by the information processing apparatus 10 according to the first embodiment are used for an employment test or a programming skill examination, explanation is not essential, and thus, provision of a web page for correct answer and a web page for incorrect answer can be omitted. Explanation data and execution result data can be omitted also in the learning database indicated in FIG. 3. The correct/incorrect flag may be changed to a score.

While in the first embodiment, a case has been described where the learning service is provided as a web application that runs on a web browser, if questions related to the learning service can be provided to the user, a provision form is not limited to a web application. For example, the learning service according to the first embodiment may be provided as a native application dedicated for an OS installed in a smartphone, a tablet, and the like. The questions that can be provided by the learning service according to the first embodiment may be described in application pages constituting the native application and provided.

The questions to be provided by the learning service according to the first embodiment have a multiple-choice form, and thus, can be suitably utilized as questions of a learning service for a mobile information processing terminal such as a smartphone which has trouble in input of characters, numbers and symbols. While questions having a multiple choice form are provided by programming questions for a smartphone in related art so as to allow the user to easily operate, the provided questions are only questions that ask knowledge such as questions that ask terms, questions that find mistakes and fill-in-blank questions. According to the learning service according to the first embodiment, questions capable of causing the user to acquire skills necessary at actual development sites such as skills of imagining a source code from an execution result and skills of assembling an execution result from a source code in his/her head can be provided to the user while enabling learning with simple operation by utilizing a smartphone.

### Second Embodiment

The questions provided in the first embodiment are questions that cause the user to select one source code from which an execution result is expanded from a plurality of source codes. However, questions that cause the user to select one source code that satisfies requirements of documents to be used for creating a source code from a plurality of source codes may be provided. An information processing apparatus 40 according to a second embodiment will be described below. The information processing apparatus 40 according to the second embodiment differs from the information processing apparatus 10 according to the first embodiment only in questions to be provided, and a hardware configuration, and the like, are the same as those in the first embodiment, and thus, description thereof will be omitted.

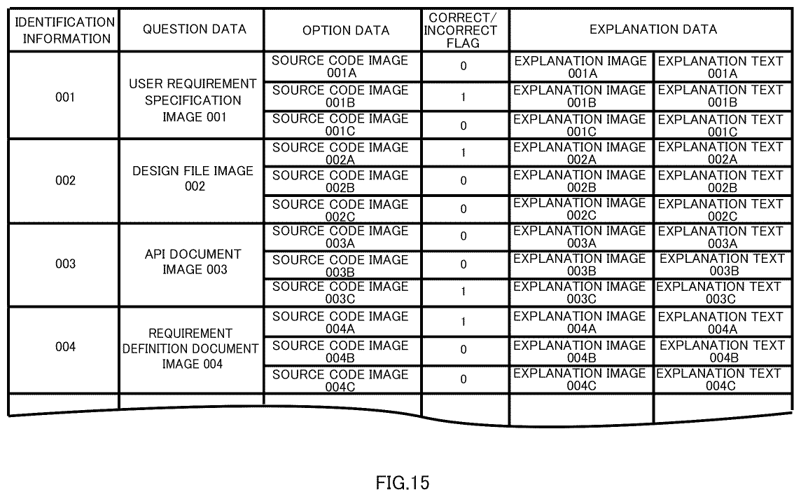

The information processing apparatus 40 according to the second embodiment stores a learning database indicated in FIG. 15. FIG. 15 indicates an example of the learning database stored in the information processing apparatus 40 according to the second embodiment. As indicated in FIG. 15, in the learning database, question data, option data, a correct/incorrect flag and explanation data are associated with identification information for identifying the question. In the second embodiment, the question data is provided by data of an image representing documents necessary to create a source code.

Note that in the second embodiment, arbitrary documents that can be used for creating a source code can be used as the “documents”. Specifically, the documents are defined to include user requirement specifications in which requirements of a client are summarized, requirement definition documents in which functions necessary for a system to satisfy the requirements and methods for implementing the functions are summarized, a design file that specifies various materials that constitute web pages, and the like, text, color information, arrangement, and the like, an API document that specifies a package that aggregates javadoc comment, an interface, a class, and the like, in Java in an HTML format, and the like.

Thus, the question data is provided by an image representing the user requirement specifications (user requirement specification image), an image representing the requirement definition documents (requirement definition document image), an image representing the design file (design file image), and an image representing the API document (API document image).

According to the information processing apparatus 40 according to the second embodiment, by causing the web page for providing a question including the documents necessary to create a source code and a plurality of source code images to be displayed at the user terminal 30, a question that causes the user to select a source code which is created along the documents and which satisfies requirements of the documents from the plurality of source codes can be provided to the user. The user has to read each of the source codes from the top and determine whether each of the source codes is created along the documents in order to answer the question. In other words, it is possible to cause the user to semi-forcibly read the whole of each of the source codes through the question, so that it is possible to cause the user to naturally acquire skills of reading a source code by causing the user to repeatedly answer such a question. Further, a source code is created along provided documents also at actual development sites, and thus, it is possible to cause the user to gain experience close to actual experience by answering the question. For example, by causing the user to read a correct source code that is actually created and a source code which is actually created and which includes a mistake portion for one user requirement specification, it is possible to cause the user to experience in a pseudo manner what kind of mistake is actually made in a development process of a product based on the user requirement specification through the question. By causing the user to answer the question that can be provided by the information processing apparatus 40 according to the second embodiment in this manner, it is possible to cause the user to acquire skills of creating a source code from documents that are guidelines for creating the source code and cultivate human resources capable of playing active roles at actual development sites.

This effect is difficult to obtain from a question that causes the user to select documents used in creation of a source code from a plurality of documents. This is because a clear difference appears in the plurality of documents, and thus, the user can select correct documents without reading the whole source code by only focusing attention on a source code portion in which the difference appears. Further, while work of imagining and creating a source code on the basis of provided documents is performed at actual development sites, work of imagining or creating documents on the basis of a source code is not performed, and thus, causing the user to answer a question that causes the user to select documents corresponding to a source code from a plurality of documents does not make much sense.

In this manner, the question that causes the user to select a source code along the documents from a plurality of source codes provided by the information processing apparatus 40 according to the second embodiment has clear advantages over a question that causes the user to select documents corresponding to a source code from a plurality of documents.

### Third Embodiment

A question to be provided to the user by an information processing apparatus 50 according to a third embodiment is not a question that causes the user to select an appropriate source code from a plurality of source codes as in the first and the second embodiments but a question that causes the user to correct a mistake portion in the source code. The information processing apparatus 50 according to the third embodiment will be described below. The information processing apparatus 50 according to the third embodiment differs from the information processing apparatus 10 according to the first embodiment only in a question to be provided, and a hardware configuration, and the like, are the same as those in the first embodiment, and thus, description thereof will be omitted.

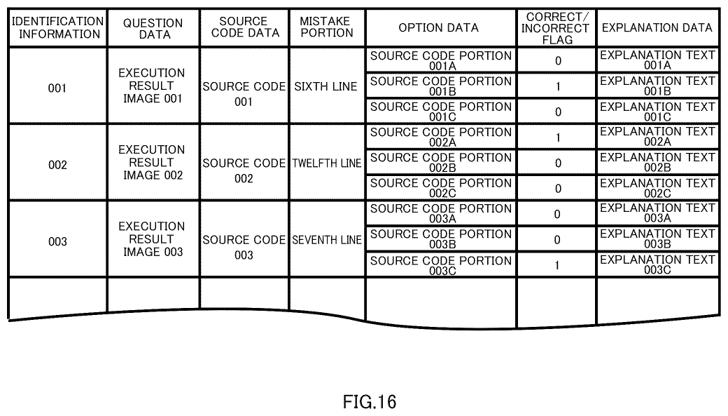

The information processing apparatus 50 according to the third embodiment stores a learning database indicated in FIG. 16. FIG. 16 indicates an example of the learning database stored in the information processing apparatus 50 according to the third embodiment. As indicated in FIG. 16, in the learning database, question data, source code data, a mistake portion, option data, a correct/incorrect flag and explanation data are associated with identification information for identifying the question. The question data is provided by data of an image representing an execution result (execution result image). The source code data is provided by text data of a source code from which the execution result that is the question data is expanded. The mistake portion is information for specifying a mistake portion in the source code. The option data is provided by a plurality of source code portions. The source code portion is a candidate with which a portion that is a mistake portion in the source code is to be replaced.

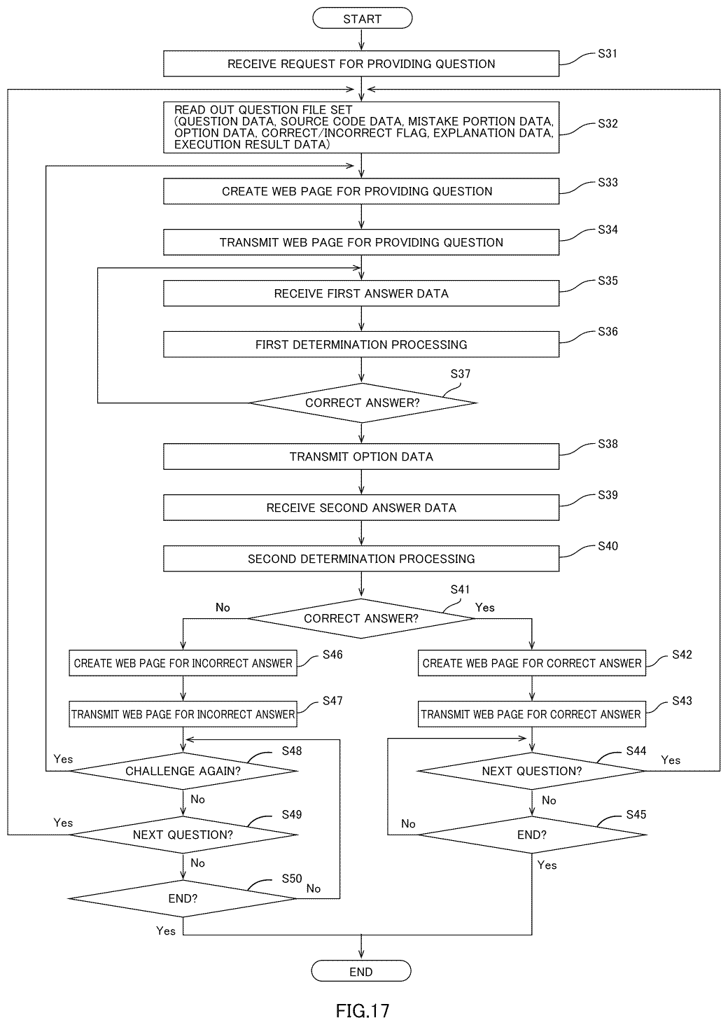

Procedure of processing of providing a question related to a learning service by the information processing apparatus 50 according to the third embodiment will be described below with reference to FIG. 17. Note that the processing of providing a question by the information processing apparatus 50 according to the third embodiment indicated in FIG. 17 and the processing of providing a question by the information processing apparatus 10 according to the first embodiment indicated in FIG. 7 have many common steps. Thus, only a difference from FIG. 7 will be mainly described.

As indicated in FIG. 17, if the information processing apparatus 50 receives a request for providing a question (S31), the information processing apparatus 50 specifies a collection of questions corresponding to the identification information and reads out a question file set (question data, source code data, a mistake portion, option data, a correct/incorrect flag and explanation data) corresponding to the first question with reference to a question database of the specified collection of questions (S32). Then, the information processing apparatus 50 creates a web page 590 for providing a question in which the question data and the option data are put in a template 500 of the web page for providing a question (S33) and transmits data of the created web page 590 for providing a question to the user terminal 30 (S34).

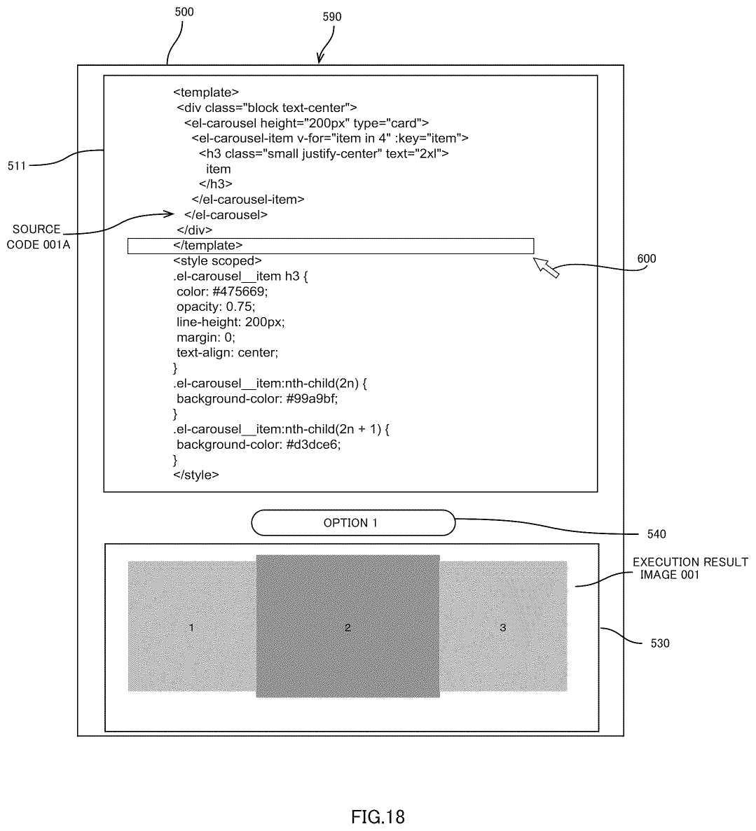

For example, in a case where a question including the identification information of “001” in the question database indicated in FIG. 16 is provided, the web page 590 for providing a question illustrated in FIG. 18 is created by putting the source code data 001 in an area 511 of the template 500 and putting the execution result image 001 in an area 530 through the processing in step S33, and the web page 590 for providing a question is displayed at the user terminal 30 through the processing in step S34. For example, as illustrated in FIG. 18, if a source code portion of the source code displayed in the web page 590 for providing a question is selected by a cursor 600, first answer data including information that specifies the source code portion selected by the user is transmitted to the user terminal 30.

If the information processing apparatus 50 receives the first answer data from the user terminal 30 (S35), the information processing apparatus 50 determines whether the mistake portion is correct or incorrect in accordance with the first answer data (S36). For example, if a line number indicating the mistake portion in the learning database matches a line number of the source code portion selected by the user, the information processing apparatus 50 determines that the answer of the user is correct, and if the line numbers do not match each other, the information processing apparatus 50 determines that the answer of the user is incorrect.

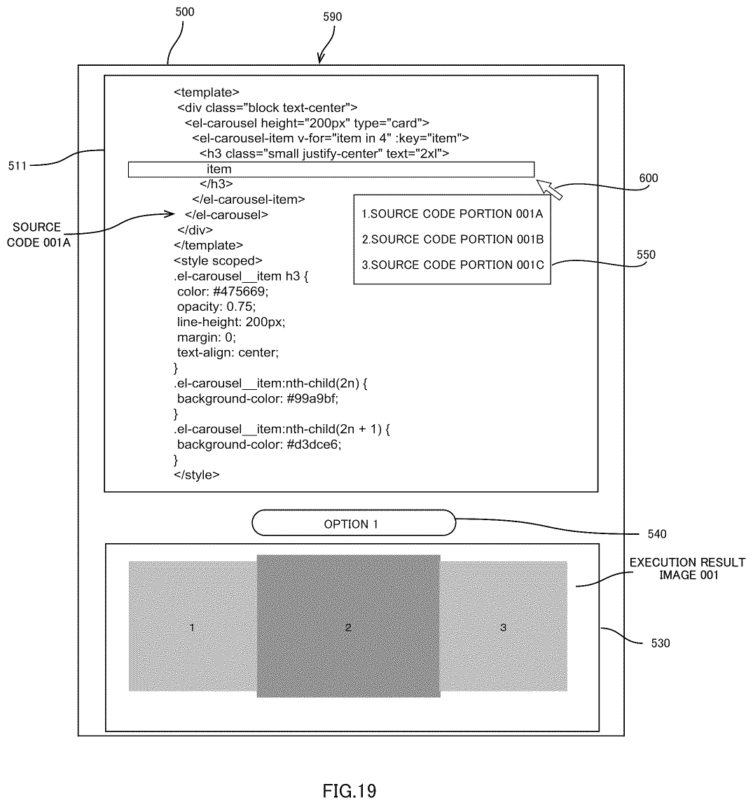

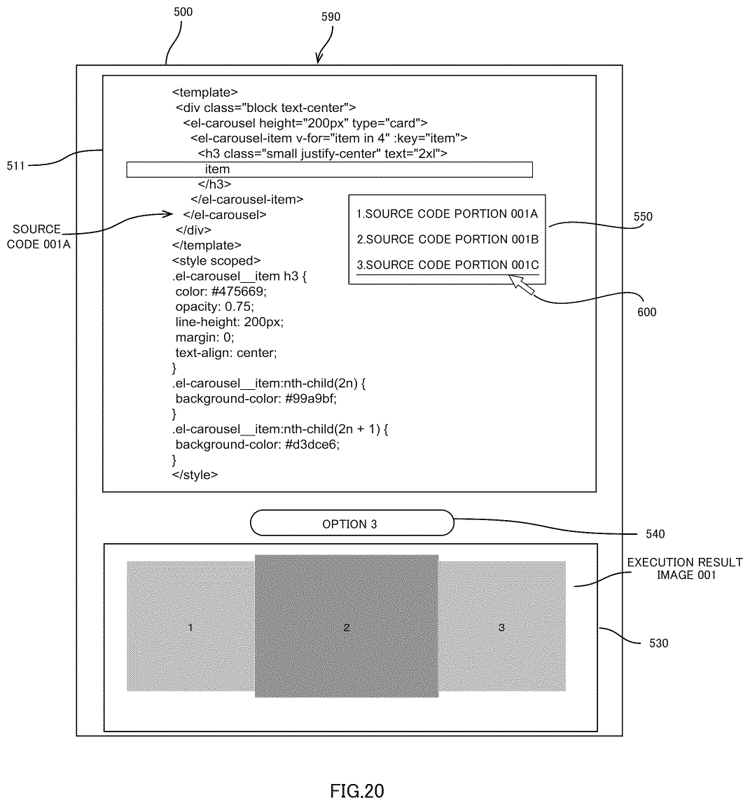

The information processing apparatus 50 stands by until the first answer by the user becomes correct (S37: No) and transmits data of a plurality of source code portions as option data to the user terminal 30 (S38) by being triggered by the first answer becoming correct (S37: Yes). By the processing in step S38, an area 550 which describes a plurality of source code portions as option data is displayed in the web page 590 for providing a question at the user terminal 30 as illustrated in FIG. 19. For example, as illustrated in FIG. 20, if the source code portion 001C is selected from the plurality of source code portions 001A. 001B and 001C in the web page 590 for providing a question, and an answer button 540 is clicked, second answer data including information that specifies the source code portion 001C is transmitted from the user terminal 30 to the information processing apparatus 50.

If the information processing apparatus 50 receives the second answer data from the user terminal 30 (S39), the information processing apparatus 50 determines whether the source code portion is correct or incorrect in accordance with the second answer data (S40). For example, if the correct/incorrect flag is “0”, the information processing apparatus 50 determines that the answer of the user is incorrect, and if the correct/incorrect flag is “1”, the information processing apparatus 50 determines that the answer of the user is correct with reference to the correct/incorrect flag corresponding to the source code portion selected by the user. Processing from step S41 to step S50 after the determination processing of the source code portion respectively correspond to the processing from step S17 to step S26 in FIG. 7, and thus, description will be omitted.

According to the information processing apparatus 50 according to the third embodiment, by causing the web page for providing a question including the execution result, the source code and the plurality of source code portions to be displayed at the user terminal 30, it is possible to provide a question that causes the user to point a mistake portion in the source code from which an execution result is to be expanded and further select a source code portion with which the mistake portion is to be replaced from a plurality of source code portions, to the user. The user has to read the source code from the top, assemble an execution result of the source code in his/her head and find a mistake portion of the source code in order to answer the question. In other words, it is possible to cause the user to semi-forcibly read the whole of each of the source codes through the question, so that it is possible to cause the user to acquire skills of reading a source code by causing the user to repeatedly answer such a question. Further, the user has to select a source code portion to correct the found mistake portion from a plurality of source code portions. Work of finding a mistake portion in a source code and correcting the mistake portion is repeatedly executed also at actual development sites. In this manner, it is possible to cause the user to experience work that is also performed at actual development sites through a question. By causing the user to answer the question that can be provided by the information processing apparatus 50 according to the third embodiment, it is possible to cultivate human resources capable of playing active roles at actual development sites.

Further, the following supplementary notes will be disclosed regarding the present embodiment and modifications.

(Appendix 1) An information processing apparatus comprising: a storage unit that stores a source code, an execution result corresponding to the source code, and a plurality of source code portions which are candidates for a portion with which part of the source code is to be replaced in association with one another; a creation unit that creates a question page including the execution result and the source code: a first transmission unit that transmits data of the question page to a user terminal: a first reception unit that receives from the user terminal, first answer data, of the source code, that specifies a mistake portion designated by a user who operates the user terminal: a first determination unit that determines whether the mistake portion of the source code is correct or incorrect in accordance with the first answer data: a second transmission unit that transmits the plurality of source code portions to the user terminal to display the plurality of source code portions in the question page in a case where a determination result of the first determination unit is positive: a second reception unit that receives from the user terminal, second answer data that specifies a source code portion selected by the user who operates the user terminal among the plurality of source code portions: a second determination unit that determines whether a source code with which the mistake portion is to be replaced is correct or incorrect in accordance with the second answer data; and a third transmission unit that transmits a determination result of the second determination unit to the user terminal.

### (Appendix 2)

An information processing apparatus comprising: a storage unit that stores a source code, documents used for creating one source code among a plurality of source codes, and a plurality of source code portions which are candidates for a portion with which part of the source code is to be replaced in association with one another: a creation unit that creates a question page including the documents and the source code: a first transmission unit that transmits data of the question page to a user terminal: a first reception unit that receives from the user terminal, first answer data, of the source code, that specifies a mistake portion designated by a user who operates the user terminal: a first determination unit that determines whether the mistake portion of the source code is correct or incorrect in accordance with the first answer data: a second transmission unit that transmits the plurality of source code portions to the user terminal to display the plurality of source code portions in the question page in a case where a determination result of the first determination unit is positive: a second reception unit that receives from the user terminal, second answer data that specifies a source code portion selected by the user who operates the user terminal among the plurality of source code portions; a second determination unit that determines whether a source code with which the mistake portion is to be replaced is correct or incorrect in accordance with the second answer data: and a third transmission unit that transmits a determination result of the second determination unit to the user terminal.

While the embodiments of the present disclosure have been described in detail, the present disclosure is not limited to the above-described individual embodiments. Various additions, replacements, changes, partial deletions, and the like, can be made to these embodiments within a range not deviating from the scope of the invention or within a range not deviating from idea and gist of the present invention derived from recitation of the claims and equivalents thereof. For example, in the above-described embodiments, the order of respective kinds of operation and the order of respective kinds of processing are described as one example, and the present invention is not limited to these. Further, the same applies to a case where numerical values or expressions are used in the above-described description of the embodiments.

1. An information processing apparatus comprising:
a storage unit that stores a plurality of images respectively representing a plurality of source codes and an execution result corresponding to one source code among the plurality of source codes in association with each other;
a creation unit that creates a question page for providing a question that asks skills of imagining a source code from an execution result to a user, the question page including the plurality of images and the execution result;
a first transmission unit that transmits data of the question page to a user terminal;
a reception unit that receives from the user terminal, answer data that specifies a selected image selected by a user who operates the user terminal among the plurality of images;
a determination unit that determines whether an answer to the question is correct or incorrect in accordance with the answer data; and
a second transmission unit that transmits a determination result as to whether the answer is correct or incorrect to the user terminal.

2. The information processing apparatus according to claim 1,
wherein the storage unit stores the plurality of images respectively representing the plurality of source codes, and a plurality of execution results respectively corresponding to the plurality of source codes, and
the second transmission unit transmits an execution result corresponding to the selected image to the user terminal along with the determination result as to whether the answer is correct or incorrect.

3. The information processing apparatus according to claim 1,
wherein the storage unit stores a plurality of pieces of explanation data respectively corresponding to the plurality of source codes along with the plurality of images respectively representing the plurality of source codes and an execution result corresponding to the one source code, and
the second transmission unit transmits explanation data corresponding to the selected image to the user terminal along with the determination result as to whether the answer is correct or incorrect.

4. The information processing apparatus according to claim 1,
wherein from at least two source codes among the plurality of source codes, the same execution result is expanded, while description is different, and
the determination unit determines whether or not the answer to the question is the best answer in accordance with the answer data.

5. An information processing apparatus comprising:
a storage unit that stores a plurality of images respectively representing a plurality of source codes, and documents used for creating one source code among the plurality of source codes;
a creation unit that creates a question page for providing a question that asks skills of creating a source code from documents that are guidelines for creating the source code to a user, the question page including the plurality of images and the documents;
a first transmission unit that transmits data of the question page to a user terminal;
a reception unit that receives from the user terminal, answer data that specifies a selected image selected by a user who operates the user terminal among the plurality of images;
a determination unit that determines whether an answer to the question is correct or incorrect in accordance with the answer data; and
a second transmission unit that transmits a determination result as to whether the answer is correct or incorrect to the user terminal.

6. The information processing apparatus according to claim 5,
wherein at least two source codes among the plurality of source codes satisfy requirements of the documents, while description is different, and
the determination unit determines whether or not an answer to the question is the best answer in accordance with the answer data.

7. The information processing apparatus according to claim 1,
wherein the creation unit creates the question page so that the plurality of images are alternatively displayed at the user terminal.

8. The information processing apparatus according to claim 5,
wherein the creation unit creates the question page so that the plurality of images are alternatively displayed at the user terminal.

9. A non-transitory storage medium storing a program causing a computer to implement:
creating a question page including a plurality of images respectively representing a plurality of source codes and an execution result corresponding to one source code among the plurality of source codes;
transmitting data of the question page to a user terminal;
receiving from the user terminal, answer data that specifies a selected image selected by a user who operates the user terminal among the plurality of images;
determining whether an answer to the question is correct or incorrect in accordance with the answer data; and
transmitting a determination result as to whether the answer is correct or incorrect to the user terminal.
